(19) United States
(12) Patent Application Publication
(10) Pub. No.: US 2008/0222906 A1
(43) Pub. Date: Sep. 18, 2008

(54) Traditional shaving razor or electrical shaving and trimming device with integrated spirit level or bubble level

(76) Inventor: Fraser Lewis Austin, New York, NY (US)

Correspondence Address: FRASER LEWIS AUSTIN, 7 Foxfire Road, Hollywood, FL, 33021, US

(21) Appl. No.: 11/724,835

(22) Filed: Mar. 17, 2007

(51) Int. Cl. G03B 17/06; B26B 21/40

(52) U.S. Cl. 33/334; 30/537

(57) ABSTRACT

This device integrates a “Spirit Level” or “Bubble Level” with a traditional shaving device such as a non-electrically powered shaving razor, or electrically powered razor or trimming device. The integration of a “Spirit Level” or “Bubble Level” with a shaving or trimming device allows for accurate, straight, and level, shaving, cutting, or trimming of facial hair, hair growing from the scalp, or any other hair growing from the body. By using the “Sprit Level” or “Bubble Level” as a guide, the user is able to gauge the exact angle at which he or she is cutting, shaving, or trimming.

### BACKGROUND OF THE INVENTION

The field of endeavor for this invention would fall into the personal grooming category, and more specifically the cutting, shaving, and trimming of body hair. I devised this invention out of the frustration of not being able to trim my moustache and beard into a straight line, leaving my “side burns” and moustache looking “crooked” and not parallel to my facial features. I had noticed that many men have “crooked” moustaches and “side burns” because it is difficult to gauge the angle of which someone is shaving or trimming due to the reverse view of a mirror. Before this invention, someone would have to “eye ball” or really on their eye to gauge the angle of which they are trimming or cutting body hair including “side burns” and moustaches. I had also come to the conclusion that hairstylists and other grooming professionals would find this invention useful in trimming or cutting straight lines and straight angles into the hair of their subjects because as long as the subject's head is straight, the stylist or grooming professional would be able to gauge the exact angle of which they will be trimming or cutting their subjects hair, whether it be hair in the back of their head, or a beard or moustache.

### BRIEF SUMMARY OF THE INVENTION

The purpose and object of this invention is to employ the incorporation of a leveling device, but mainly a “Spirit Level”, “Bubble Level”, or “Laser Level”, into either, or both, an electric or non-electrically powered shaving or grooming-device, razor or trimmer, or alike device. The resulting functionality of this invention, is the ability to cut, shave, trim, or groom, straight-lines, or straight-angled lines into, from, or out-of, facial hair, hair growing from the scalp, or body hair growing from any other part of the body, with a certain heightened degree of accuracy, compared to such a routine without employing this invention. By integrating a “Spirit Level” or “Bubble Level” with a shaving device, the user is able to see the angle of which he or she is going to cut and/or trim the aforementioned hair, thus resulting in “side burns”, moustaches, beards, scalp hair, or any other body hair appearing in a neat manner, and most importantly, in the intended manner in which they meant to shave, cut, or trim.

### BRIEF DESCRIPTION OF THE VIEWS OF THE DRAWINGS

FIG. 1:

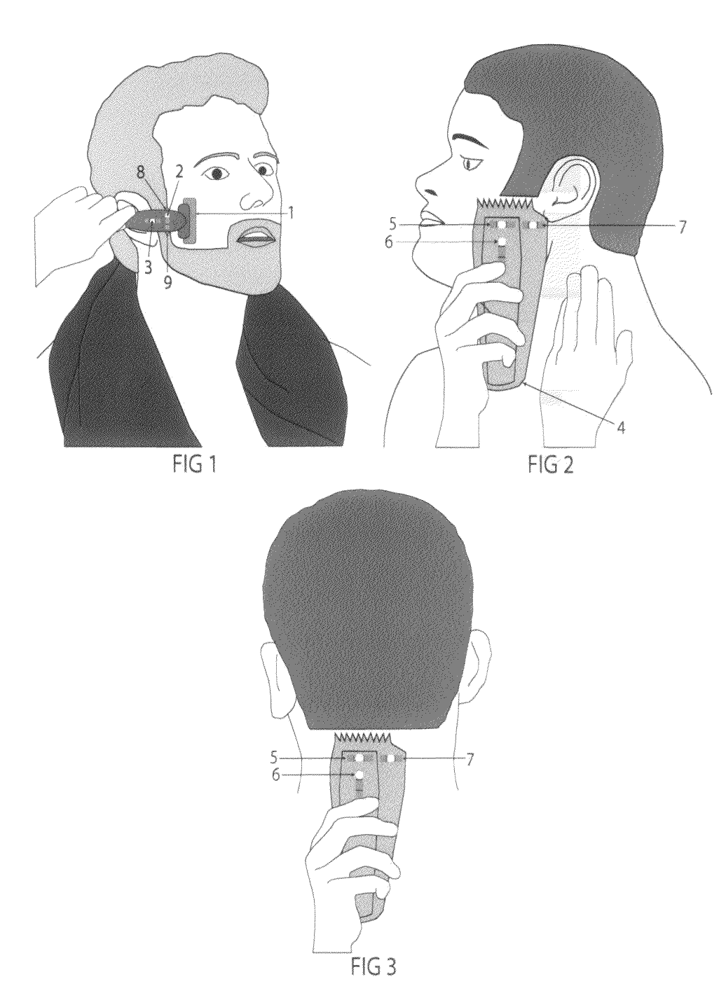

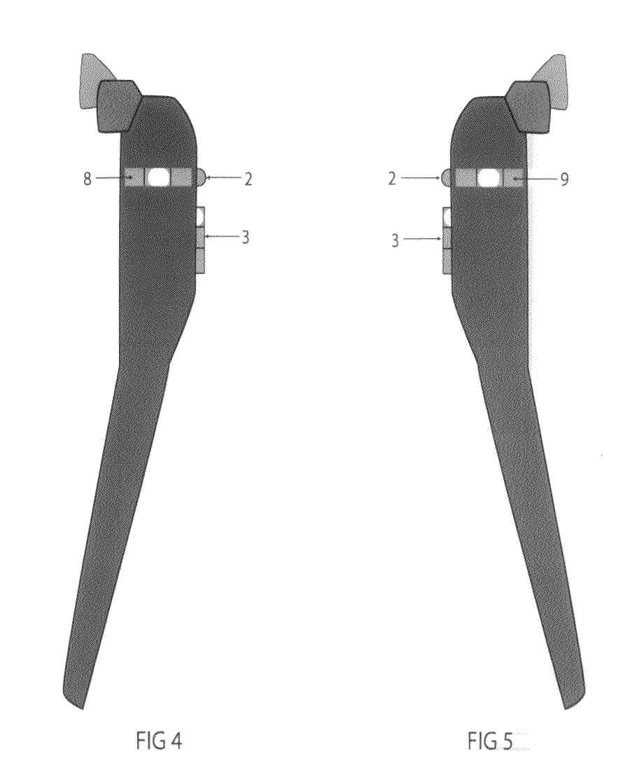

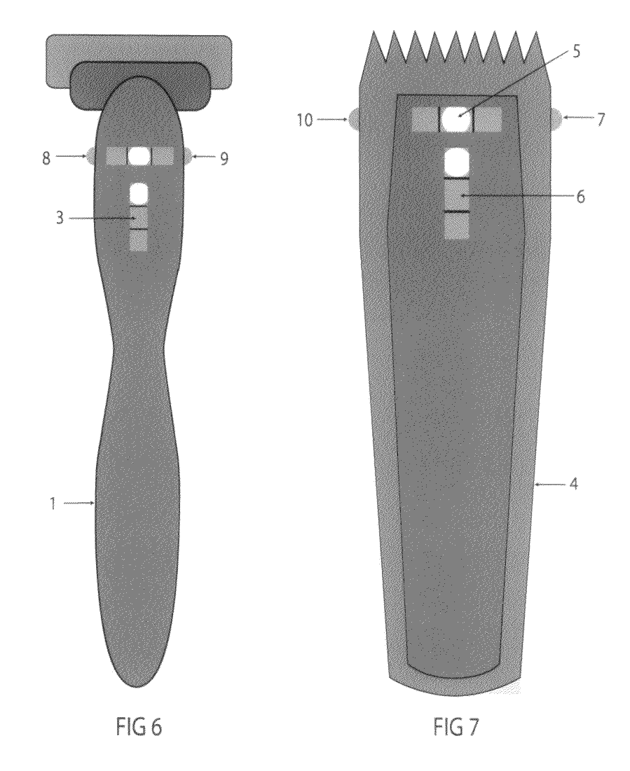

1) Front view of the body of the non-electrically powered traditional style shaving razor showing a vertically placed and horizontally placed “Spirit Level” or “Bubble Level” and also showing protrusions indicating the placement of “Spirit Levels” or “Bubble Levels” which are placed both side of the device

2) Vertically viewed “Spirit Level” or “Bubble Level”

3) Horizontally viewed “Spirit level” or “Bubble Level” indicating that the device will be trimming the side of the “side burns” at a straight angle, at 90 degrees from the man's lower beard

8) The arrow points to the protrusion from the “Bubble Level” or “Laser Level” placed horizontally on the left side of the device.

9) The arrow points to the protrusion from the “Bubble Level” or “Laser Level” placed horizontally on the right side of the device.

FIG. 2:

4) Front view of the device showing the body of the electrically powered shaving razor or trimmer, showing both a vertically placed and horizontally placed “Spirit Level” or “Bubble Level”, and also showing a “Spirit Level” or “Bubble Level” that is placed on the side of the device.

5) Horizontally viewed “Spirit level” or “Bubble Level” indicating that the device will be trimming the bottom of the “side burns” at a straight angle.

6) Vertically viewed “Spirit Level” or “Bubble Level”

7) Depicts horizontally viewed “Spirit Level” or “Bubble Level” placed on the right side of the device

FIG. 3:

5) Depicts the front of the devices horizontal “Spirit Level” or “Bubble Level” indicating that the persons hair will be cut at a straight and even angle, from left to right or right to left.

6) Vertically viewed “Spirit Level” or Bubble Level”

7) Depicts the side of the devices horizontal “Spirit Level” or “Bubble Level” indicating that the persons hair will be cut at a straight and even angle, from left to right or right to left.

FIG. 4:

2) Left side view indicating protrusion of the horizontal “Spirit Level” or “Bubble Level” placed on the front of the device.

3) Left side view indicating the vertical “Spirit Level” or “Bubble Level” placed on the front of the device.

8) Left side view indicating the horizontal “Spirit Level” or “Bubble Level” placed on the left side of the device.

FIG. 5:

2) Right side view indicating protrusion of the horizontal “Spirit Level” or “Bubble Level” placed on the front of the device.

3) Right side view indicating the vertical “Spirit Level” or “Bubble Level” placed on the front of the device.

9) Right side view indicating the horizontal “Spirit Level” or “Bubble Level” placed on the right side of the device.

FIG. 6:

1) Front view of the body of the non-electrically powered traditional style shaving razor showing a vertically placed and horizontally placed “Spirit Level” or “Bubble Level” and also showing protrusions indicating the placement of “Spirit Levels” or “Bubble Levels” which are placed both side of the device.

3) Indicates the vertically placed “Spirit Level” or “Bubble Level” when viewed from the front in an upright top to bottom view.

8) The arrow points to the protrusion from the “Bubble Level” or “Laser Level” placed horizontally on the left side of the device.

9) The arrow points to the protrusion from the “Bubble Level” or “Laser Level” placed horizontally on the right side of the device.

FIG. 7:

4) Front view showing the body of the electrically powered shaving razor or trimmer, showing both a vertically placed and horizontally placed “Spirit Level” or “Bubble Level”, and also showing a “Spirit Level” or “Bubble Level” that is placed on the side of the device.

5) Depicts the horizontal “Spirit Level” or “Bubble Level” placed on the front of the device, as viewed from the front of the device.

6) Depicts the vertically “Spirit Level” or “Bubble Level” placed on the front of the device, as viewed from the front of the device.

7) The arrow points the protrusion indicated the placement of the horizontal “Spirit Level” or “Bubble Level” which is placed on the right side of the device.

10) The arrow points the protrusion indicated the placement of the horizontal “Spirit Level” or “Bubble Level” which is placed on the left side of the device.

### DETAILED DESCRIPTION OF THE INVENTION

This device is to be used for either personal or at-home use, or commercial use by a grooming professional, hair grooming stylist or hairdresser for commercial application, which could include use in salons and barber shops etc, though not to be limited to such use, and could also be used for the grooming of animals, and animal hair, other than human.

By incorporating a “Spirit Level”, “Bubble Level”, or “Laser Level” into the aforementioned shaving and/or grooming device, the user will be given the ability to accurately trim and/or cut, neat, “level”, and straight-lines, or straight-angled, starting points or lines into or out-of, or from, facial hair, and hair growing from the scalp, or any other parts of the human body where hair growth is present, though not limited to the hair growing from any other part of the human body, or the bodies of animals other than humans, such as dogs, cats, monkeys, etcetera.

The incorporation of a “Spirit Level”, “Bubble Level”, or “Laser Level”, into the aforementioned shaving device will allow for, amongst many other purposes, the “level” and straight-line, or straight-angled, trimming of “side burns”, beards, and moustaches, though not limited to such.

The incorporation of a “Spirit Level”, “Bubble Level”, or “Laser Level”, into the aforementioned shaving device will also allow for the trimming or shaving of a “level”, straight-line, or straight-angle, into/out-of, or from, scalp hair, or any other “body hair”, to assist with the creation or design of letters of the alphabet, numbers, logos, zigzag patterns or lines, or any other graphical designs, represented as art derived from the trimming or shaving of such hair on the scalp, though not limited to such uses.

The placement of the a “Spirit Level”, or “Bubble Level”, would be fashioned in such a way that If the shaving or trimming is being performed personally by the proprietor of the hair which is being shaved or trimmed, such user will be able to gauge the proper straight-line, or straight-angle, by looking in the mirror. This is possible because the “Spirit Level” or “Bubble Level” would be placed and integrated into the shaving or trimming device in such a manner so that which it may be viewed in the mirror while such shaving or trimming is taking place.

The placement or point of integration of a “Spirit Level” or “Bubble Level” into a shaving or trimming device would consist of mounting a “Spirit Level” or “Bubble Level” into each “side” of the shaving/trimming device, or the “hollowed-out” center of the trimming or shaving device which would allow for the “Bubble Level” or “Spirit Level” to be viewed from the “side” of the device, though not limited to the possibility of being mounted and integrated on any other position on the shaving/trimming device, and therefore providing for the “Spirit Level” or “Bubble Level” to be viewed in the mirror by the user, whom is the proprietor of the hair which is being groomed on their body. A “Spirit Level” or “Bubble Level” might also be placed or integrated with the shaving or trimming device in such a way that it may be viewed from the “front” of the shaving or trimming device, the “rear” of the shaving or trimming device, or both the “front” and “rear” of the device, though not limited for the “Spirit Level” or “Bubble Level” to be placed and integrated through any other part of the shaving or trimming device.

The “Spirit Level” or “Bubble Level” used within the context of this patent submission would contain “markings” representing both straight, and level-angled marking or measuring lines, as well as angled marking or measuring lines, though not limited to having less, or more “marking” or “measuring lines” than specified within this paragraph. The function of such “marking” or “measuring” lines would serve as indicators of the type of design or angle to be shaved, and/or trimmed, from or into or out-of, the hair which is being shaved or groomed.

The typical liquid substance found within a “Spirit Level” or “Bubble Level” is ethanol, though I reserve the right to use any which liquid substance that I deem to be most effective for the application of this invention, therefore not limiting the use of ethanol as the liquid contained in the “Spirit Level” or “Bubble Level” device which shall be integrated with the shaving and/or trimming device. The typical color/s of such liquid used within a “Spirit Level” or “Bubble Level” is typically either, yellow, red, or orange, though the color of such liquid, for the application of this invention shall not be limited to any color within the color spectrum, or may also appear visibly as a clear liquid. The said liquid, contained within the “Spirit Level” or “Bubble Level” may also be lit, or illuminated, by a light source external from the “Spirit Level” or “Bubble Level” in order to create higher visibility of the measuring device, though is not limited to such.

1. (canceled)

2. A new and improved way to trim, shave, groom, and cut, facial hair, hair from the scalp, and other body hair, by integrating a “Spirit Level” or “Bubble Level”, into traditional shaving razors, and electrically powered trimmers and shavers, which will assist the user in the cutting and shaving of body hair in the desired angle or line.

3. (canceled)

4. (canceled)

5. A “Bubble Level” or “Spirit Level” is mounted on any location of the body of the traditional style non-electrically powered razor, which could include the front, rear, or both sides of the device, or in only one location of the device.

6. The “Bubble Level” or “Spirit Level” is mounted on any location of the body of electrically powered trimmers and shavers, which could include the front, rear, or both sides of the device, or in only one locations of the device.
